(19) United States
(12) Patent Application Publication
(10) Pub. No.: US 2015/0107695 A1
(43) Pub. Date: Apr. 23, 2015

(54) PROTECTIVE CAP FOR A PRESSURISED FLUID CYLINDER VALVE AND PRODUCTION METHOD THEREOF

(71) Applicant: L'Air Liquide, Société Anonyme pour l'Etude de l'Exploitation des Procédé Georges Claude, Paris (FR)

(72) Inventors: Renaud Ligonesche, Herblay (FR); Francois Trindade, Saint Priest La Feuille (FR); William Lebegue, Naillat (FR)

(21) Appl. No.: 14/394,758

(22) PCT Filed: Mar. 22, 2013
(86) PCT No.: PCT/FR2013/050620

§ 371 Date: Oct. 16, 2014

(30) Foreign Application Priority Data
Apr. 19, 2012 (FR) 1253604

(51) Int. Cl. F17C 13/06; B23K 31/02; B23P 15/00

(52) U.S. Cl. CPC F17C 13/06; B23P 15/001; B23K 31/02; F17C 2205/0308
USPC 137/382; 228/173.1

(57) ABSTRACT

The invention relates to a protective cap for a pressurised fluid cylinder valve, comprising a hoop (1) defining a sheltered protected space, the lower end of the hoop (1) being secured to the generally annular base (2) that is intended to be mounted around the neck of a pressurised fluid cylinder. The cap is characterised in that the hoop (1) comprises a draw-formed metal sheet. The invention also relates to the corresponding method.

### CROSS REFERENCE TO RELATED APPLICATIONS

This application is a 371 of International PCT Application PCT/FR2013/050620 filed Mar. 22, 2013, which claims priority to French Patent Application No. 1253604 filed Apr. 19, 2012, the entire contents of which are incorporated herein by reference.

### BACKGROUND

The present invention relates to a protective cap for a pressurized fluid cylinder valve and production method thereof.

The invention relates more particularly to a protective cap for a pressurized fluid cylinder valve comprising a hoop which defines a sheltered protective space, the lower end of the hoop being secured on a base with a generally annular form which is designed to be mounted around the neck of a pressurized fluid cylinder.

Pressurized fluid cylinders and the equipment which accompanies them are subject to safety regulations and standards.

For example, protective caps of gas cylinder valves are subject to the following standard: the standardizing test ISO 11117 and particularly resistance to impacts (at 20° C. and −20° C.). These caps must also satisfy requirements of resistance to fire and prolonged life cycles.

In order to comply with these constraints, some protective caps consist of metal. Document DE10146261 thus describes a cap which is made of molded metal, and the different parts of which are welded. However, this type of architecture and production of the cap results in a cap which is relatively heavy, and costly to produce if the mechanical strength standards are to be respected.

Document GB1529293 for its part describes a protective cap consisting of a single stamped part. However, this cap has a geometry which is not optimum for protection of all valves. In addition, this embodiment results in a cap with mechanical resistance to being dropped which is not satisfactory.

According to other known solutions, the cap is made of plastic, optionally with a metal insert (cf. EP1041339).

In general, in order to ensure all the functions required and satisfy the technical constraints, the known cap designs require a relatively large amount of material.

### SUMMARY

An object of the present invention is to eliminate some or all of the above-described disadvantages of the prior art.

An object of the invention can in particular be to propose a cap and production method thereof which make it possible to comply with the safety constraints, in particular without being to the detriment of the weight of the cap, its cost, and the possibility of providing the cap with a form which adapts to different valve geometries, whilst having an attractive appearance.

For this purpose, the cap according to the invention, which furthermore is in conformity with the generic definition given in the above preamble, is substantially characterized in that the hoop comprises a metal sheet which is formed by stamping.

In addition, embodiments of the invention can comprise one or a plurality of the following characteristics:
the upper end of the hoop comprises a protuberance on which a knob for grasping the cap is secured;
the knob is secured by being welded and/or crimped onto the upper end of the hoop;
the knob has the general form of a hollow cover which, in the position in which it is mounted on the hoop, accommodates in its interior at least part of the protuberance;
the protuberance is formed by stamping of the hoop;
the knob is secured by being welded onto the free end of the protuberance;
the knob is hollow, with the free end of the protuberance being supported against the base of the knob, whereas a lower end of the knob is supported on the upper end of the hoop and/or on another portion of the protuberance;
the free upper end of the knob is convex towards the exterior of the cap;
the base comprises a metal part which is distinct from the hoop, and has the general form of an open ring, two opposite ends of which are provided with respective passages for a clamping shaft of the said ring, the lower end of the hoop being secured on the base by being welded and/or crimped;
the lower end of the hoop comprises two half-rings forming a circular collar which surrounds the base around a fraction of the circumference of the base contained between 20% and 100% and preferably between 60% and 100%;
the base consists of a metal part formed by stamping;
the hoop comprises at least one rib which extends in the direction of curving of the hoop, the said at least one rib being formed by a stamping fold;
the protuberance is open at its upper end;
the protuberance has the general form of a truncated cone, the diameter of which decreases in the direction of its free end;
the protuberance has the general form of a truncated cone which converges discontinuously in the direction of its free end, i.e. the protuberance defines a convex and/or concave portion on its outer surface;
the base comprises a mounting portion with a generally tubular form, which is designed to be mounted around a cylinder neck, the upper end of the mounting portion being curved perpendicularly to the axis of the tubular portion in order to form a rim which is secured on the lower end of the hoop;
the hoop is at least partially convex towards the exterior of the protective space;
the passages for a clamping shaft of the said ring which are formed at the ends of the open ring formed by the base are situated on respective perforated plates which are integral with the base or added onto the base; the knob consists of a metal part formed by stamping;
at least one out of the: hoop, base, knob consists of at least one of the following materials: a metal material, a steel preferably with characteristics which are the same as, or better than, those of a structural steel, for example a steel of type S355MC according to the standard NF EN 10149.2, with a yield point of Re=355 (MPa) and rupture strength of Rm=430 to 550 (MPa);
at least one out of the: hoop, base, knob has a thickness of between 0.5 and 10 mm and preferably between 1 and 4 mm, or any other appropriate thickness according to the load weight, the stresses, and the forms of the stamped part;
the circumference of the base has at least one projection or one recess, which respectively is received or receives a complementary recess or projection formed at the lower end of the hoop.

The invention also relates to a pressurized fluid cylinder provided with a valve and a cap to protect the valve according to any one of the preceding or following characteristics.

The invention also relates to a method for production of a protective cap for a pressurized fluid cylinder valve according to any one of the preceding or following characteristics, comprising:
a step of production of a hoop by stamping of a metal sheet; and
a step of welding the lower end of the hoop onto a base with a generally annular form.

### According to Other Possible Features:

during the step of production of a hoop by stamping of a metal sheet, a protuberance is provided on the upper end of the hoop, the method additionally comprising a step of welding a knob onto the said protuberance;
the step of welding the lower end of the hoop onto a base with a generally annular form is preceded by a step of production of the base by stamping of a metal sheet;
the lower end of the hoop forms a circular collar, and during the step of welding of the lower end of the hoop onto a base, the lower end of the hoop surrounds 60% to 100% of the circumference of the base;
before the step of welding the lower end of the hoop onto a base with a generally annular form, the base is introduced between the branches of the hoop via the protected space, from the top downwards with reference to the upper and lower ends of the hoop.

The invention can also relate to any alternative device or method comprising any combination of the preceding or following characteristics.

### BRIEF DESCRIPTION OF THE DRAWINGS

Other features and advantages will become apparent from reading the following description, provided with reference to the figures in which:

FIG. 1 represents a view in perspective of a possible embodiment of a protective cap according to the invention;

FIG. 2 represents a rear view of the cap in FIG. 1;

FIG. 3 represents a partial view in perspective from below of the cap in FIG. 1;

FIG. 4 represents a view in cross section according to a vertical plane of the cap in FIG. 1;

FIG. 5 represents a view in cross section according to a vertical plane of the cap in FIG. 1 mounted on a cylinder, illustrating schematically an impact on the ground;

FIG. 6 represents a partial schematic view illustrating an example of possible production steps of the cap in FIG. 1.

### DESCRIPTION OF PREFERRED EMBODIMENTS

The protective cap for a pressurized fluid cylinder valve illustrated in the figures comprises a hoop 1 which defines a sheltered protected space, and the lower end of which is secured on a base 2 with a generally annular form which is designed to be mounted around the neck of a pressurized fluid cylinder. The “lower” and “upper” ends indicate the ends of the cap which are situated respectively at the base 2 and opposite the base 2.

For example, the hoop 1 has the general form of an inverted “U”, the two lower ends of the branches of which “U” are secured on the base 2. As represented, the two lower ends of the branches of the “U” which are secured on the base 2 are not parallel, but converge slightly.

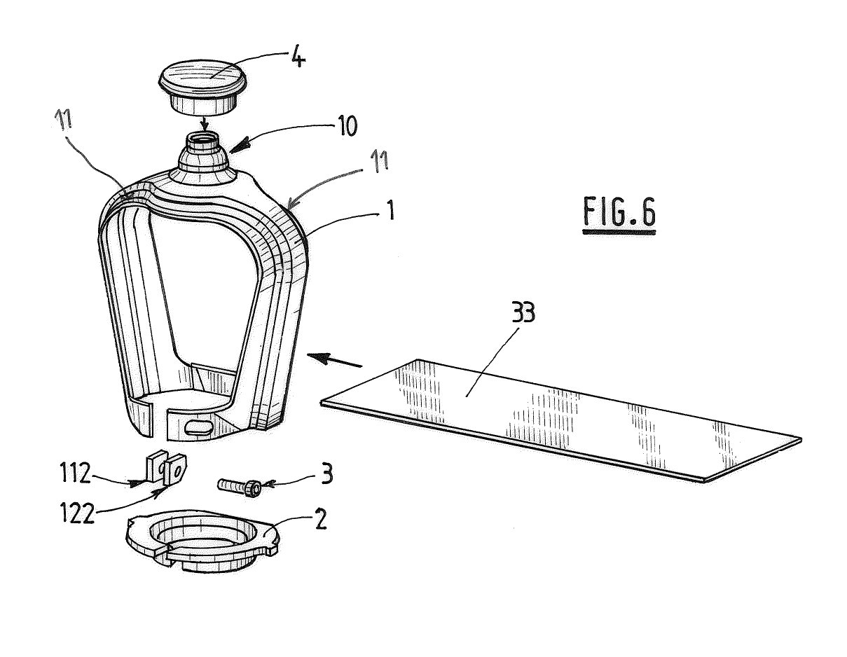

According to an advantageous characteristic, the hoop 1 consists of (and is preferably constituted by) a metal sheet 33 which is formed by stamping (cf. FIG. 6).

As will be described in greater detail hereinafter, this characteristic makes it possible to provide the cap with good mechanical strength, whilst using a relatively slight thickness of material. The hoop 1 preferably consists of at least one of the materials from amongst: a steel, a stainless steel, a steel with a coating of the cataphoresis type, or an aluminum with treatment of the anodization type.

All types of appropriate metal materials can be envisaged, if applicable, with treatment(s) designed for example to protect against corrosion, or for the finishing appearance, etc.). These materials provide the cap with good resistance to fire, as well as to corrosion.

This structure also makes it possible, by means of ribs and/or folds and/or bosses, to increase the mechanical strength or to improve the distribution of the forces sustained by the cap in the case of an impact, in comparison with the known solutions.

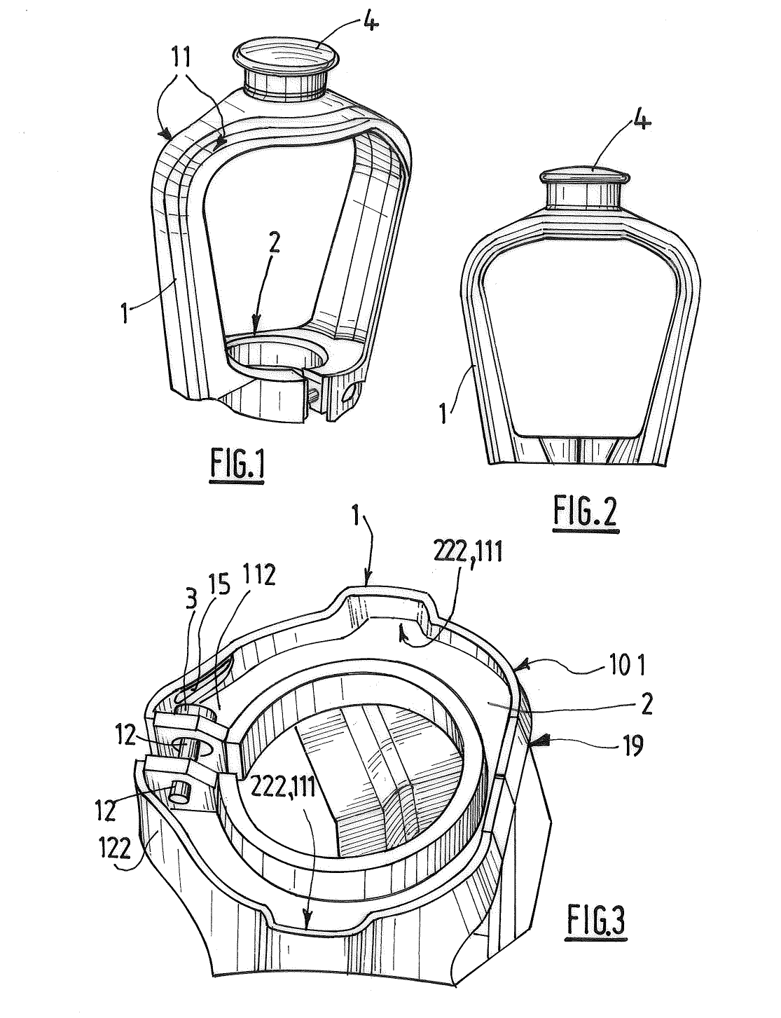

As can be seen in FIG. 1, the hoop 1 can comprise at least one (and for example two ribs 11) which extends in the direction of curving of the hoop. The rib(s) 11 can be formed by a stamping fold of the metal sheet. For example, two ribs 11 form a shoulder which extends over all or part of the hoop 1, and in the direction of curving of the hoop 1.

The hoop 1 can be at least partially convex towards the exterior of the protective space. The thickness of the hoop 1 is for example between 0.5 mm and 10 mm, and preferably between 1 mm and 4 mm. It will be appreciated that this thickness can be adapted according to the application, the load weight, the stresses expected, and the stamped forms of the cap.

The base 2 comprises a metal part which is distinct from the hoop 1 which preferably has the general form of an open ring, thus forming a securing flange. The two opposite ends of the ring are for example provided with respective passages 12, 22 for a clamping shaft 3 of the said ring. The passages 12, 22 (which are optionally tapped) for the clamping shaft 3 (which is optionally threaded) can be respective perforated plates 112, 122, which are integral with the base 2 or are added onto the base 2.

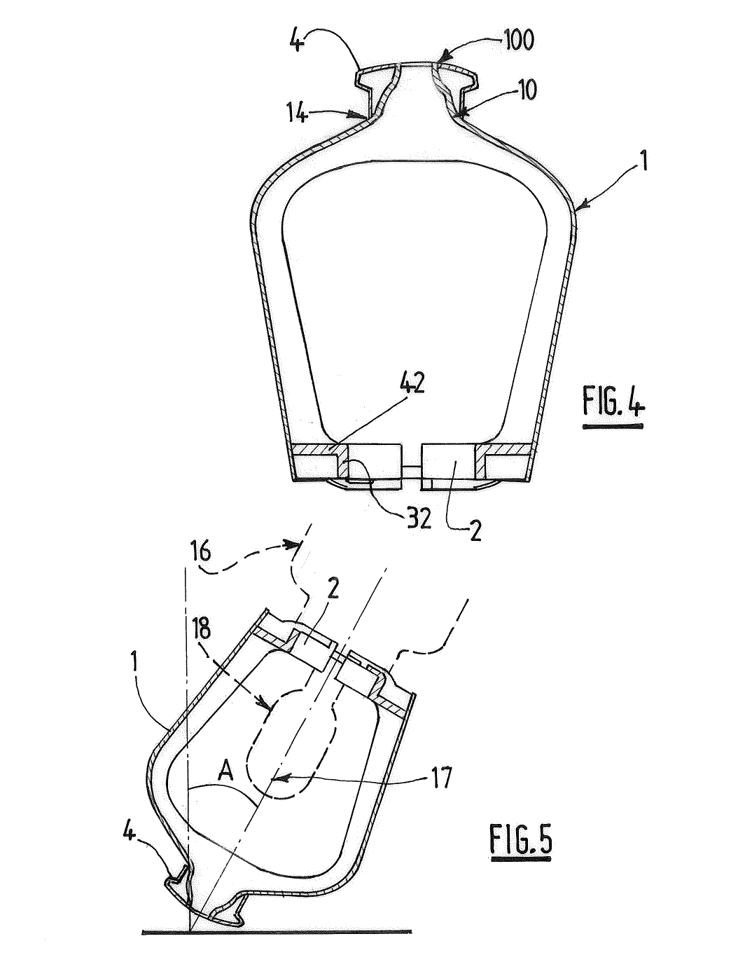

As can be seen in FIGS. 3 and 4, the base 2 can comprise a mounting portion 32 with a generally tubular form 2 which is designed to be mounted around a cylinder neck. The upper end of the mounting portion 32 can be curved perpendicularly to the axis of the tubular portion, towards the exterior of the tubular part, in order to form a rim 42 which is secured on the lower end of the hoop 1.

For example, the lower end of the hoop 1 is secured on the base 2 by being welded and/or crimped, or by any other appropriate technique.

For example, the lower end of the hoop 1 comprises two half-rings forming a circular collar 101 which surrounds the base 2 around a portion of between 60% and 100% of the circumference of the base 2. In other words, each lower end of the two branches of the hoop 1 is integral (and preferably in a single piece) with a half-ring which is secured on part of the periphery of the base 2. As can be seen in FIG. 3, the circumference of the base 2 can have at least one projection 222 (two projections 222 in the example in FIG. 3) received by a respective recess 111 formed at the lower end of the hoop 1. For example, the recesses 11 are formed by an end of the rib(s) 11 of the hoop 1.

This configuration ensures mechanical blocking in rotation of the hoop 1 relative to the base 2, which in addition improves the transmission and dissipation of forces within the cap in the event of an impact. These forms also participate in the indexing of the hoop on the base 2 during the welding phase. As a variant, or in combination with the foregoing, the base 2 could comprise one or more recesses which cooperate with respective projections preferably formed by ribs or bosses of the hoop 1.

Also, preferably, part of the circumference of the base 2 and therefore part of the lower end of the hoop 1 has a flattened part 19. The flattened part 19 is for example situated opposite the part provided with a clamping shaft 3. The flattened part 19 is for example designed to facilitate access to the protected space. The flattened part 19 thus forms a localized contraction which provides a passage for fluid connections, for example.

As can be seen in FIG. 4, the hoop 1 is for example welded on the edge of the rim 42 formed by the base 2 (preferably according to a plurality of welding spots distributed around the periphery of the base 2).

As can be seen in FIGS. 2 and 3 in particular, the base 2 need not project beyond the lower end of the hoop 1. Thus, the passages 12, 22 and the clamping shaft are protected by the hoop 1. An opening 15 can be provided through the lower end of the hoop 1 in order to access the clamping shaft 3.

The base 2 can also consist of a metal part formed by stamping. As a variant, the base 2 could be obtained by molding of a metal material. Preferably, the base consists of the same material as the hoop 1.

Since the lower ends of the hoop 1 are not parallel (but convergent), the base 2 can have a transverse dimension larger than the space between the lower terminal ends of the hoop 1. Consequently, the base 2 is introduced between the two branches of the hoop 1 from the top downwards, via the protected space of the hoop 1 (cf. FIGS. 4 and 6). In other words, the base 2 can be clamped in the hoop 1.

The upper end of the hoop 1 preferably comprises a knob 4 for retention of the cap (and therefore of the cylinder provided with the cap).

According to a particularly advantageous possible feature, the upper end of the hoop 1 comprises a protuberance 10 on which the knob 4 is secured.

Preferably, the knob 4 is also made of metal, and is secured by being welded and/or crimped onto the upper end of the hoop 1.

As can be seen in FIG. 4, the protuberance 10 can be formed by stamping during the production of the hoop 1. For example, the protuberance 10 has the general form of a truncated cone, the diameter of which decreases (not necessarily continuously) in the direction of its free end 100.

The protuberance 10 can be open at its upper end 100. In addition, the protuberance 10 can define at least one convex and/or concave portion on its outer surface.

As can be seen in FIG. 4, the knob 4 can be in the form of a hollow cover which, in the position in which it is mounted on the hoop 1, receives at least part of the protuberance 10 in its interior.

For example, the free end of the protuberance 10 is supported against the base of the knob 4, and forms a welding area between these two parts. The lower end 14 of the knob 4 can be supported (or be fitted/welded, etc.) on the upper end of the hoop 1 and/or on another portion of the protuberance 10.

Preferably, the knob 4 provides a manual holding grip, for example a rim on the periphery.

Also preferably, the free upper end of the knob 4 is convex towards the exterior of the cap. As well as improving the ergonomics of the manual grip, this configuration improves the resistance to impacts of the cap as described hereinafter.

FIG. 5 illustrates schematically and partially an example of impact of the cap on the ground. The cap is mounted on a cylinder 16 and strikes the ground with an angle A of 30° relative to the vertical axis 17 of the cylinder and of the cap. This configuration is obtained for example by suspending the cylinder upside down (for example 1.20 m above the ground). According to this dropping test (standard ISO 11117), the knob 4 strikes the impact plane first.

Because of its structure and its mounting on the hoop 1, under the effect of the impact the knob 4 can be deformed and absorb a first part of the energy generated by the impact. In addition, simultaneously or in a second stage, the profile of the protuberance 10 on which the knob 4 is mounted distributes the force within the hoop 1 and as far as the base 2. This limits excessively localized deformations which can give rise to deformation which affects the valve 18 situated in the protective space.

During impact, the convex form of the knob 4 also ensures contact which generates sliding of the cap, followed by a moment of rotation of the assembly. Simulations and tests indicate that this moment of rotation limits considerably the impact on the cap.

It can thus easily be understood that, whilst having a simple and inexpensive structure, the cap according to the invention is particularly effective in terms of protection and resistance to impacts.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-15. (canceled)

16. A protective cap for a pressurized fluid cylinder valve comprising a hoop which defines a sheltered protective space, the lower end of the hoop being secured on a base with a generally annular form which is designed to be mounted around the neck of a pressurized fluid cylinder, the hoop comprising a metal sheet which is formed by stamping, wherein the upper end of the hoop comprises a protuberance on which a knob for grasping the cap is secured, and the knob has the general form of a hollow cover which, in the position in which it is mounted on the hoop, accommodates in its interior at least part of the protuberance.

17. The cap of claim 16, wherein the knob is secured by being welded or crimped onto the upper end of the hoop.

18. The cap of claim 16, wherein the protuberance is formed by stamping of the hoop.

19. The cap of claim 16, wherein the knob is secured by being welded onto the free end of the protuberance.

20. The cap of claim 16, wherein the knob is hollow, the free end of the protuberance resting against the base of the knob while a lower end of the knob rests on the upper end of the hoop or on another portion of the protuberance.

21. The cap of claim 16, wherein the free upper end of the knob is convex facing toward the outside of the cap.

22. The cap of claim 16, wherein the base comprises a metal part which is distinct from the hoop, and has the general form of an open ring, two opposite ends of which are provided with respective passages for a clamping shaft of the said ring, the lower end of the hoop being secured on the base by being welded or crimped.

23. The cap of claim 22, wherein the lower end of the hoop comprises two half-rings forming a circular collar which surrounds the base around a fraction of the circumference of the base contained between 20% and 100%.

24. The cap of claim 16, wherein the base consists of a metal part formed by stamping.

25. The cap of claim 16, wherein the hoop comprises at least one rib which extends in the direction of curving of the hoop, the said at least one rib being formed by a stamping fold.

26. The cap of claim 16, wherein the hoop is at least partially convex toward the exterior of the protective space.

27. The cap of claim 16, wherein the protuberance has the overall shape of a cone frustum the diameter of which decreases in the direction of its free end.

28. A pressurized fluid cylinder provided with a valve and a cap to protect the valve, wherein the cap is in accordance with claim 16.

29. A method for production of a protective cap for a pressurized fluid cylinder valve according to claim 16, comprising:
a step of production of a hoop by stamping of a metal sheet; and
a step of welding the lower end of the hoop onto a base with a generally annular form.

30. The production method of claim 29, wherein during the step of production of a hoop by stamping of a metal sheet, a protuberance is produced on the upper end of the hoop, the method further comprising a step of welding a knob onto said protuberance.
